(19) United States
(12) Patent Application Publication
(10) Pub. No.: US 2025/0118174 A1
(43) Pub. Date: Apr. 10, 2025

(54) SYSTEM AND METHOD FOR SELF-CHECKOUT USING SELF-DEACTIVATING TAGS

(71) Applicant: SENSORMATIC ELECTRONICS, LLC, Boca Raton, FL (US)

(72) Inventors: Mohammad MOHIUDDIN, Boynton Beach, FL (US); Adam S. BERGMAN, Boca Raton, FL (US); Channing E. MILLER, Boca Raton, FL (US)

(21) Appl. No.: 18/275,576

(22) PCT Filed: Feb. 3, 2022
(86) PCT No.: PCT/US2022/070514

§ 371 Date: Aug. 14, 2024

Related U.S. Application Data
(60) Provisional application No. 63/145,274, filed on Feb. 3, 2021.

(51) Int. Cl. G07G 1/00

(52) U.S. Cl. CPC G07G 1/0009

(57) ABSTRACT

Example aspects include techniques for implementing self-checkout via self-deactivating security tags. These techniques may include verifying, via communications with a server device, payment for a product using an electronic device. In addition, the techniques may include unlocking, via a pad of a kiosk, a security tag from the product based at least in part on confirmation of the payment for the product.

### CROSS-REFERENCE TO RELATED APPLICATION

This application claims priority to U.S. Patent Application No. 63/145,274, entitled “A SELF-CHECKOUT SYSTEM AND METHOD THEREOF,” filed on Feb. 3, 2021, the disclosure of which is incorporated by reference herein in their entirety.

### BACKGROUND

Products or items present in the retail stores are provided with security tags that may be one of radio frequency identification (RFID) tags or electrical article surveillance (EAS) tags. The EAS tags can be RFID or non-RFID whereas either can be implemented to prevent theft of products from retail store.

The conventional checkout process occurs at a fixed Point of Sale or a kiosk station manned by a store associate. The store associate assists a customer with the checkout process by receiving payment for item(s). If the item is associated with an EAS/RFID element, the store sales associate uses a tag detacher to remove the security tag from the purchased item.

Often, during peak hours, when customer traffic is high, conventional checkout process become a tedious and time consuming process. Customers may be required to wait in long queue for successful payment and detachment of tags. The conventional checkout process may get additionally delayed when there is a shortage of manpower and/or a detacher is not easily available.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A first example implementation includes a system comprising a security tag attached to a product, and a kiosk comprising: a pad for placement of security tags; and a memory storing computer-executable instructions and at least one processor coupled with the memory and configured to: verify, via communications with a server device, payment for the product; and unlock, via the pad, the security tag from the product based at least in part on confirmation of the payment for the product.

A second example implementation includes a method comprising verifying, by a kiosk, via communications with a server device, payment for a product scanned by an electronic device; transmitting, by the kiosk, to a security tag attached to the product based at least in part on the verifying, a command including an identifier of the security tag and/or the product, the command approving unlocking of the security tag; and unlocking, by the kiosk, the security tag from the product based at least in part on confirmation of the payment for the product.

The disclosure also provides an apparatus including a memory storing computer-executable instructions and at least one processor configured to execute the computer-executable instructions to perform the above method, an apparatus including means for performing the above method, and a non-transitory computer-readable medium storing computer-executable instructions for performing the above method.

A third example implementation includes a method comprising scanning, by an electronic device, a product attached to a security tag, receiving payment for the product via the electronic device, and energizing the security tag in response to verification of the payment of the product associated with the security tag wherein the energy harvested in the security tag energization is utilized by the security tag to unlock the security tag from the product.

The disclosure also provides an apparatus including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects include the features hereinafter fully described and particularly pointed out in the claims. The following description and the annexed drawings set forth in detail some illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram illustrating an example layout of a retail environment, in accordance with various aspects of the present disclosure.

FIG. 2 is a diagram illustrating an example product attached with a security tag, in accordance with various aspects of the present disclosure.

FIG. 3A is a plan view of an example EAS portal, in accordance with various aspects of the present disclosure.

FIG. 3B is a top view of an example EAS portal, in accordance with various aspects of the present disclosure.

FIG. 4 is a diagram illustrating an example self-checkout system for the retail environment, in accordance with various aspects of the present disclosure.

FIG. 5 is a diagram illustrating an example apparatus, in accordance with various aspects of the present disclosure.

FIG. 6 is a first example method for self-checkout for a user within a retail environment, in accordance with various aspects of the present disclosure.

FIG. 7 is a second example method for self-checkout for a user within a retail environment, in accordance with various aspects of the present disclosure.

### DETAILED DESCRIPTION

It will be readily understood that the components of the aspects as generally described herein and illustrated in the appended figures could be arranged and designed in a wide variety of different configurations. Thus, the following more detailed description of various aspects, as represented in the figures, is not intended to limit the scope of the present disclosure, but is merely representative of various aspects. While the various aspects of the aspects are presented in drawings, the drawings are not necessarily drawn to scale unless specifically indicated.

The present solution may be embodied in other specific forms without departing from its spirit or essential characteristics. The described aspects are to be considered in all respects only as illustrative and not restrictive. The scope of the present solution is indicated by the appended claims rather than by this detailed description. All changes that come within the meaning and range of equivalency of the claims are to be embraced within their scope.

Reference throughout this specification to features, advantages, or similar language does not imply that all of the features and advantages that may be realized with the present solution should be or are in any single aspect of the present solution. Rather, language referring to the features and advantages is understood to mean that a specific feature, advantage, or characteristic described in connection with an aspect is included in at least one aspect of the present solution. Thus, discussions of the features and advantages, and similar language, throughout the specification may, but do not necessarily, refer to the same aspect.

Furthermore, the described features, advantages, and characteristics of the present solution may be combined in any suitable manner in one or more aspects. One skilled in the relevant art will recognize, in light of the description herein, that the present solution can be practiced without one or more of the specific features or advantages of a particular aspect. In other instances, additional features and advantages may be recognized in certain aspects that may not be present in all aspects of the present solution.

Reference throughout this specification to “one aspect,” “an aspect,” or similar language means that a particular feature, structure, or characteristic described in connection with the indicated aspect is included in at least one aspect of the present solution. Thus, the phrases “in one aspect”, “in an aspect,” and similar language throughout this specification may, but do not necessarily, all refer to the same aspect.

As used in this document, the singular form “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

Implementations of the present disclosure provide systems, methods, and apparatuses that provide secure self-checkout. These systems, methods, and apparatuses will be described in the following detailed description and illustrated in the accompanying drawings by various modules, blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In some implementations, one or more problems solved by the present solution are retail checkout inefficiency and/or delay. For example, this present disclosure describes systems and methods for secure self-checkout in a retail environment by employing an electronic device and/or kiosk device in combination with a self-deactivating tag. In some aspects, a shopper may collect one or more items (e.g., products, articles, etc.) for purchase within a retail environment, scan the collected items using an electronic device, and purchase the collecting items using the electronic device. At the time of collection, each item may be attached to a self-deactivating security tag of an EAS system that may trigger an alarm in response to unauthorized movement of the collected items. In some aspects, the security tag may include an EAS component for physical security, a communication component (e.g., an RFID component), and be configured to self-detach from an item using harvested energy from a near field inductive charger. Further, the electronic device may notify a server device of receipt of payment for the collected items. In some aspects, an electronic device or a self-checkout kiosk may include an electronic magnetic communication mechanism that emits electromagnetic energy for the security tags to harvest and use for a detachment mechanism. Accordingly, the server device may indicate, to an electronic device or a kiosk device, the each of the items that have been purchased by the shopper, and the electronic device or a kiosk device may remove each of the security tags by energizing the tag, thereby permitting the shopper to exit the retail environment with the purchased items. As such, the present solution reduces dependency on store associates for checkout and obviates the need for a detacher at or within the kiosk.

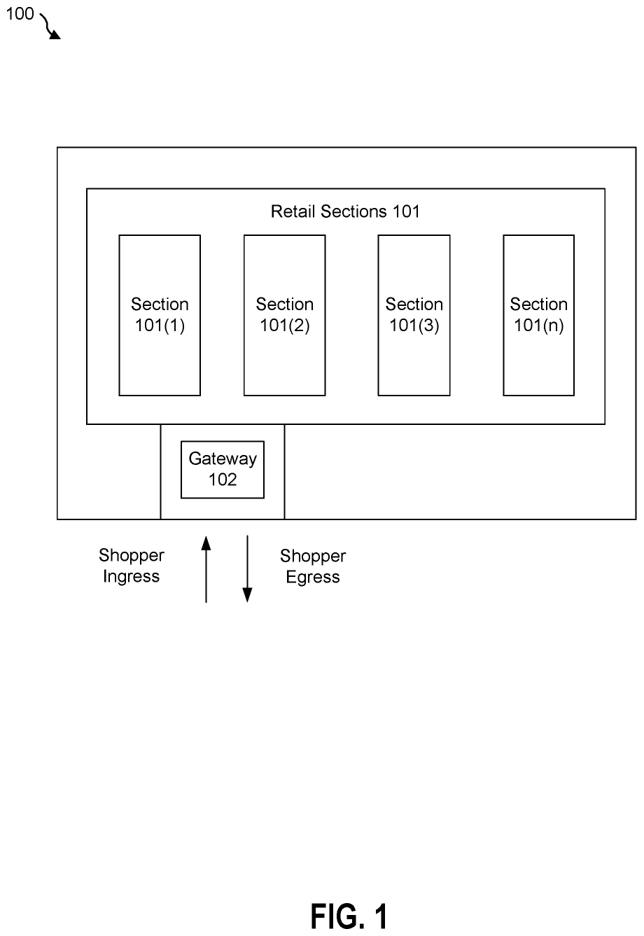

Referring now to FIG. 1, an example layout of a retail environment 100 is shown, according to some aspects. The retail environment 100 is shown to comprise a retail section 101 having one or more sections for display and sale of products. In an aspect, the retail section 101 may correspond to a fashion department of the retail environment 100, wherein section 101(1) may relate to menswear section, section 101(2) may relate to womenswear section, section 101(3) may relate to kids wear section, and section 101(4) may relate to section comprising products which are required for daily needs e.g. handkerchiefs, caps, handbags, wallet and the like.

A user may be allowed to enter and exit the retail environment 100 through a gateway 102. FIG. 1 is shown to have a gateway 102 having the entrance and exit ways adjacent to each other, however the entrance and exit ways may be at different points. Furthermore, the retail environment 100 may have more than one gateway to provide ease.

Though the retail section 101 is shown as a fashion wear outlet, the retail section 101 is not limited to only fashion department and may comprise an outlet for any retail products e.g. furniture, kitchenware, electronics, and the like. A user (a person who has entered the retail environment 100 for shopping) may access one or more products which he/she intends to purchase. For example, the user may scan a unique code associated with product(s) by means of a user device (e.g., an electronic device) subsequent to which the user may be directed towards a payment link embedded in the code for the payment.

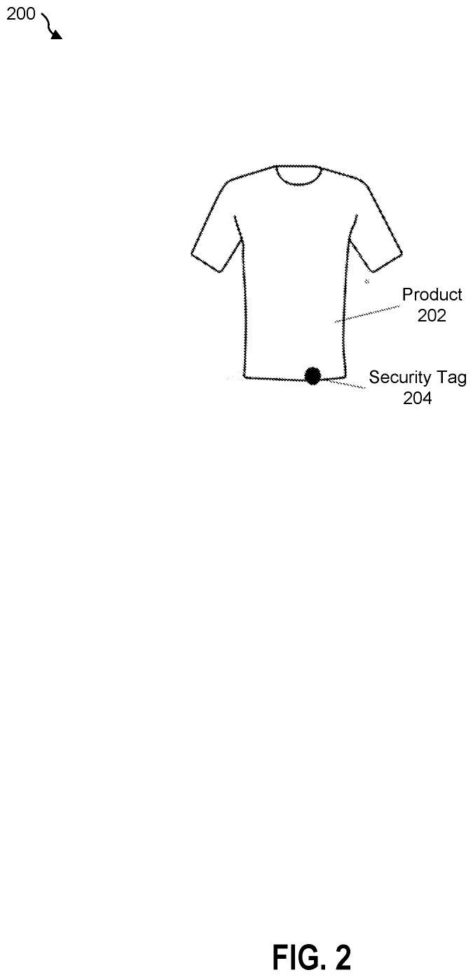

Referring to FIG. 2, an example product 202 is shown that is attached with a security tag 204, according to some aspects. In an aspect the security tag 204 is one of an RFID or an EAS tag. The security tag 204 as described in FIG. 2 includes a number of bits of storage. The security tags 204 may store information including, but not limited to, type, cost, ID of the associated product, i.e., product 202 to which the security tag 204 is attached or pinned. The security tag 204 may be manufactured with a pre-set unique Tag ID. In alternate aspects, the security tag 204 may be a read only tag, a WORM (write once, read many) tag, or a read/write tag. As is known in the art, read only RFID tags contain unique information that cannot be changed. WORM tags may be encoded a single time and then locked into a read only state. Read/write RFID tags allow for unlimited updating and transfer of information to the tag. The RFID tag may take the form of a thin flexible label or ticket that may be affixed to an object, such as a card. The security tag 204 may also be an electronic article surveillance (EAS) tag. In general, the RFID tag or EAS tag would be attached to a product to prevent shoplifting.

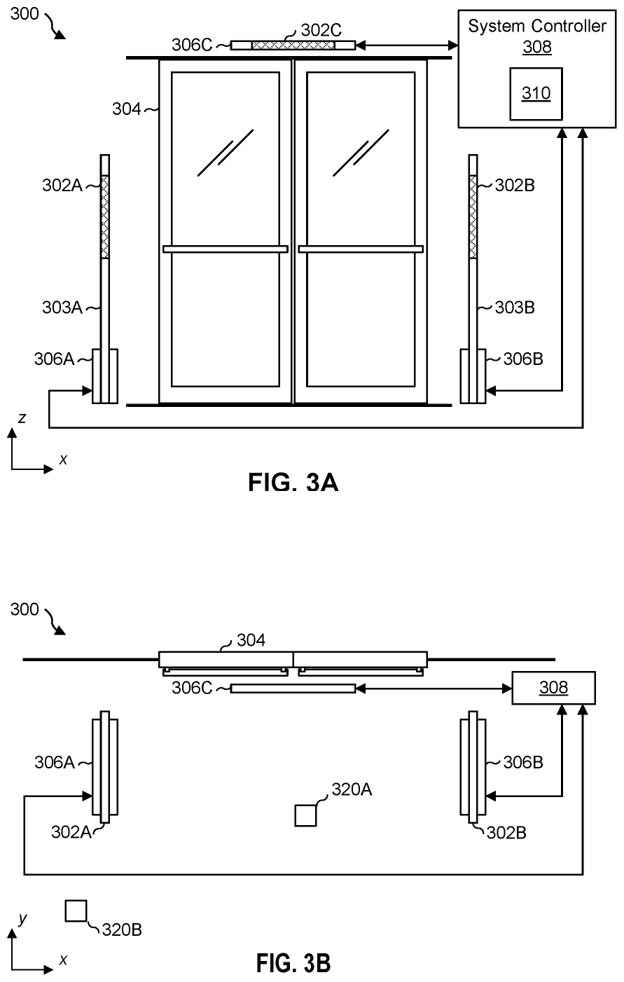

Referring now to FIGS. 3A-3B, there is provided a schematic illustration (plan view in FIG. 3A and top view in FIG. 3B) of an example EAS portal 300 that is useful for understanding the present solution. The present solution is described herein in relation to a retail store environment. The present solution is not limited in this regard, and can be used in other environments. For example, the present solution can be used in distribution centers, factories and other commercial environments. Notably, the present solution can be employed in any environment in which objects and/or items/articles/products are located and/or tracked.

The EAS portal 300 may include security readers (e.g., RFID readers) 306A, 306B, 306C (hereinafter “306”, generally) configured to read security tags. Each security reader 306 may be respectively attached to antennas 302A, 302B, 302C (hereinafter “302”, generally) mounted on the sides of the EAS portal 300. The security reader 306 as referenced herein may be capable of generating tag exciter signals (RFID exciter signals) to control and elicit responses from one or more of a plurality of security tags (such as security tags 320A-320B, hereinafter “320” generally) in an EAS portal zone. The exciter signals may also serve as a source of power for energizing the security tags 320. The exciter signals generated by the security readers 306 and responses received by each security reader 306 may be in accordance with an RFID system standard that is now known or known in the future. Alternatively or additionally, the security readers 306 may detect, identify, and/or process one or more the responses from the plurality of security tags 320 in the EAS portal zone. The security readers 306 may include suitable interface circuitry to facilitate communications with a system controller 308 (e.g., a server) as described below. For example, the interface circuitry may facilitate communication of information regarding detected responses received from security tags 320. Such interface circuitry may also facilitate reception of interrogation commands and/or antenna beam control commands from the system controller 308.

The security tags 320 may each comprise identification information, such as a serial number, an electronic product code (“EPC”), and a stock keeping unit (“SKU”) number, that uniquely identifies each security tag 320. As such, the security tags 320 may respond to the security readers 306 by providing the respective identification information.

In the EAS portal 300 shown, the antennas 302 may be mounted on pedestals 303A, 303B (hereinafter “303,” generally) and/or in the ceiling (e.g., 302C), but the technology disclosed herein is not limited in this regard. For example, antennas 302 may be mounted in the ground, and the method described herein would still be applicable. There is no restriction regarding the type of antennas 302 that are used to produce the required field patterns. For example, antennas 302 may be beam steerable so that multiple different antenna beam directions may be obtained from a single antenna 302. Alternatively or additionally, the security reader 306 may comprise multiple antennas 302. Control over the required antenna field patterns may be facilitated by the security readers 306 as noted above. In addition, three antennas, 302A, 302B, and 302C, are shown in FIGS. 3A-3B, but it should be understood that the technology disclosed herein is not limited in this regard. For example, the inventive arrangements described herein may be implemented using a single beam steerable antenna. In another example, the inventive arrangements described herein may be implemented using additional antennas.

The EAS portal 300 may be placed in the vicinity of an entrance and/or exit point in a premise (e.g., retail store facility) where products may pass through in order to transition from one space inside the premise to a second space, which is outside of the premise. In the example shown in FIGS. 3A-3B, the EAS portal is located in the vicinity of a doorway 304, but the technology disclosed herein is not limited in this regard. The entrance/exit/choke point may also be a wide exit such as those seen in shopping malls, which is open to another interior space, which is not part of the premise.

The security readers 306 may be operated under the command of a system controller 308, such as a server device, for example, which facilitates the detection of the one or more security tags 320 within a field of view of each antenna 302 as hereinafter described. The system controller 308 may be situated local to the premise, as shown in FIGS. 3A-3B, or may be located in a remote location. The system controller 308 may be configured to write data to and/or read data from security readers 306 and/or security tags 320.

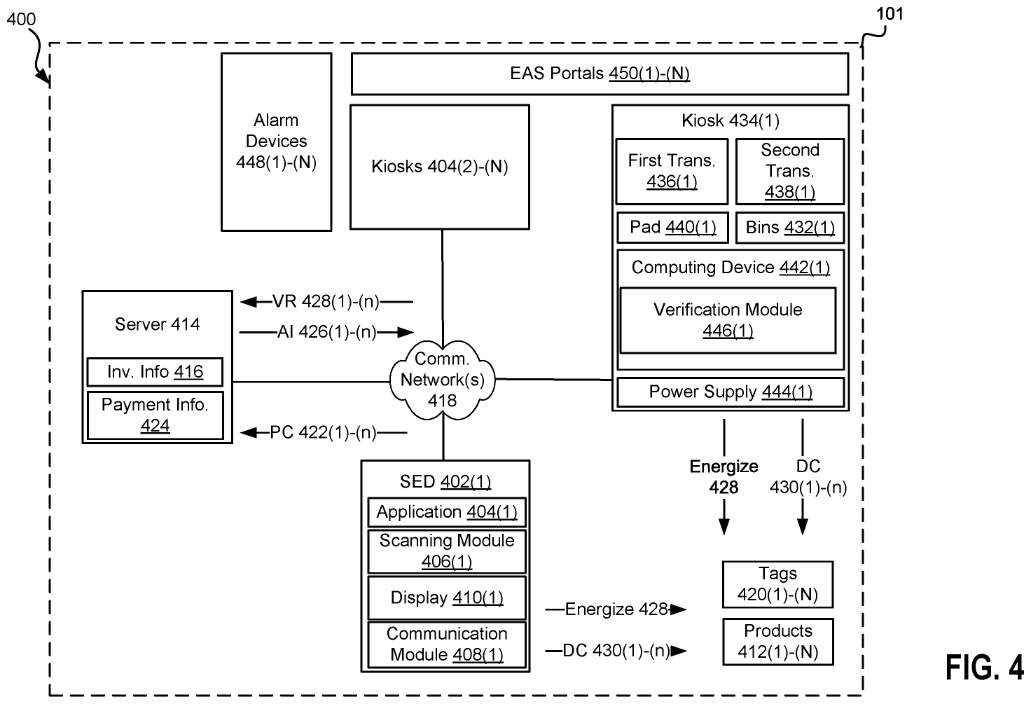

Referring to FIG. 4, an example self-checkout system 400 for the retail environment 100 is shown, according to some aspects.

In an aspect, the users may be provided with electronic devices 402(1)-(n) at the entrance of the retail environment 100. An electronic device 402 may comprise an application 404, a scanning module 406, and a communication module 408, a display 410, and others components (e.g., memory, a user interface, and a battery). In some other aspects, the user may use his or her smartphone, tablet, smart watch or any handheld or wearable computing device as an electronic device 402. For example, the user's smartphone may be considered as an electronic device 402 when the application 404 developed by or otherwise associated with the service providers of the retail environment 100 is installed on the smartphone. In an aspect, usage of smartphone with the application 404 provides better security for a user while shopping in the retail environment, especially during payment process. In some aspects, the scanning module 406 may enable the electronic device 402 to scan and extract one or more details of a product 412 selected by the customer. In some aspects, the scanning may be enabled by RFID, NFC, a camera enabled to read a code, etc.

The user may explore one or more departments present in the retail environment 100 and may select one or more products (412(1)-412(n)). When the user selects a product for purchasing, the user may scan the product 412 and extract the details via the electronic device 402. In some aspects, the details may comprise a name of the product 412, a retail price of the product 412, an identifier of the product 412 (e.g., a serial number), an expiry date and the like. In an aspect, the electronic device 402 may periodically update the list of products 412 selected by the user for purchase on a server device 414.

In some aspects, the server device 414 may be configured to maintain the record of products 412(1)-(n) present in the retail environment 100 as inventory information 416. Further, the electronic device 402 may communicate with the server device 414 via the communication module 408. In some aspects, the communication module 408 may be configured to enable exchange of data with the server device 414 via a communications network 418.

In an aspect, the display 410 may display a user interface including the list of products selected by the user for purchasing (i.e., the list of products scanned using the electronic device 402). Additionally, the display 410 of the electronic device 402 may also show the total retail price of all the selected products which is to be paid by the user. In an aspect, once the user has finalized the products which the user intends to purchase, the user may proceed to perform a self—checkout process.

The user may self-checkout from the retail environment 100 in two aspects. The first aspect may comprise the usage of the electronic device 402 and the security tag 420. After finalization the list of products for purchase, the user may pay the total price through the application 404 installed within the electronic device 402. After completion of the payment transaction, the electronic device 402 may update the record of purchased products. For example, the application 404 may send a payment confirmation 422 to the server device 414 to be stored as payment information 424. In response, the electronic device 402 may receive approval information 426 instructing the application 404 to unlock the security tags 420 of the purchased products 412. Further, the electronic device 402 to energize 428 the security tag 420 and transmit a detach command 430 to the security tags 420. The energization results in harvesting energy in the security tag 420 which is used for unlocking the security tag 420 when a detach command 430 has been received. In some aspects, the detach command 430 may include an identifier indicating that a particular security tag 420 should be unlocked to avoid use of the energization 428 to unlock a security tag 420 of an unpurchased product 412. Once, the security tag 420 is unlocked the user may then remove the unlocked security tag 420 and drop it in a nearby catching bin 432.

In another aspect of the self-checkout process, the user proceeds to a kiosk 434 along with the selected products 412 and the electronic device 402. The kiosk 434 may comprise a first transmitter 436, a second transmitter 438, a pad 440, one or more catch bins 432, a computing device 442, and a power supply 444. The user at the kiosk 434 may pay the total price displayed on the display 410 of the electronic device 402. In an aspect, the electronic device 402 may display a unique code e.g. a QR code for payment. The user may pay the total amount electronically by using his or her e-wallet or smartphone. In some other aspects, the electronic device 402 or kiosk 434 may receive other payment information (e.g., credit card, debit card, gift certificate) for purchasing the products 412.

Upon completion of payment of the products, the electronic device 402 or kiosk 434 may update the record of purchased products 412. For example, the application 404 may send a payment confirmation 422 to the server device 414 to be stored as payment information 424. After payment, the user may place the products 412 and the attached security tags 420 on the pad 440 of the kiosk 434. In some aspects, the first transmitter 436 provided near the pad 440 detects the security tag 420 and the second transmitter 438 may be configured to transmit a signal to the server device 414 to confirm the payment for the product 412 locked by the security tag 420 placed on the pad 440. In some aspects, a verification module 446 of the computing device 442 may be configured to transmit a verification request 448 including an identifier of the product 412 or the security tag 420. Upon receipt of the verification request 448, the server device 414 may determine if the payment information 424 indicates that the user has paid for the product 412. If the user has paid for the product 412, the server device 414 may transmit approval information 426 to the verification module 446 via the second transmitter 438.

After confirmation of the payment for the product 412 associated with the security tag 420 by the verification module 446 via the approval information 426, the first transmitter 436 may be configured to transmit a command to the pad 440. In response to the command, the pad 440 may transmit a detach command 430 to the security tag 420 and energize the security tag 420 placed on the pad 440 which results in harvesting energy that is sufficient for the security tag 420 to detach automatically by unlocking the security tag 420. The unlocked security tag 420 may be then dropped within the catch bins 432. As described herein, the process to detach the security tag 420 is operated by the computing device 442.

The self-checkout system 400 may also include an alarm device 450 configured to generate alarm information to alert personnel, such as employees of the retail store, police officers, security guards, or any other person, to the unauthorized removal of the products 412(1)-(n). For example, the alarm device 130 may generate alert information in response to detecting a security tag 420 in proximity to an EAS portal 452. Examples of the alarm device 450 may include one or more of an audio alarm device (e.g., horn), a visual alarm device (e.g., light), a computing device (e.g., personal computer, laptop, mobile device) that receives messages such as text or email (or any form of communication), or any other device capable of alerting personnel of the unauthorized removal of the products 412(1)-(n).

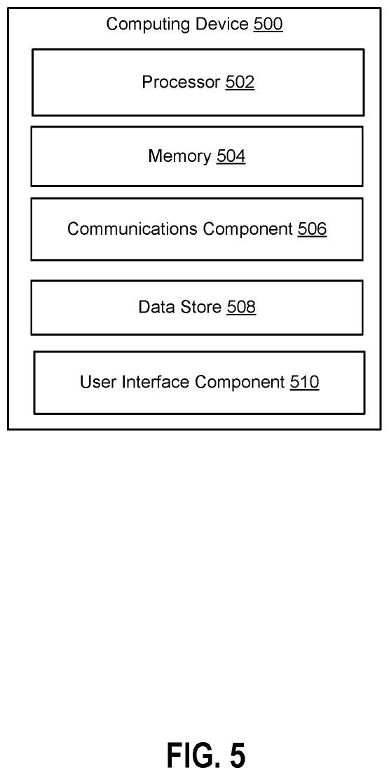

Referring to FIG. 5, a computing device 500 may implement all or a portion of the functionality described herein. The computing device 500 may be or may include or may be configured to implement the functionality of at least a portion of the electronic device 402, server device 414 or kiosk 434, or any component therein. For example, the computing device 500 may be or may include or may be configured to implement the functionality of the kiosk 434. The computing device 500 includes a processor 502 which may be configured to execute or implement software, hardware, and/or firmware modules that perform any functionality described herein. For example, the processor 502 may be configured to execute or implement software, hardware, and/or firmware modules that perform any functionality described herein with reference to the electronic device 402, server device 414 or kiosk 434.

The processor 502 may be a micro-controller, an application-specific integrated circuit (ASIC), a digital signal processor (DSP), or a field-programmable gate array (FPGA), and/or may include a single or multiple set of processors or multi-core processors. Moreover, the processor 502 may be implemented as an integrated processing system and/or a distributed processing system. The computing device 500 may further include a memory 504, such as for storing local versions of applications being executed by the processor 502, related instructions, parameters, etc. The memory 504 may include a type of memory usable by a computer, such as random access memory (RAM), read only memory (ROM), tapes, magnetic discs, optical discs, volatile memory, non-volatile memory, and any combination thereof. Additionally, the processor 502 and the memory 504 may include and execute an operating system executing on the processor 502, one or more applications, display drivers, and/or other components of the computing device 500.

Further, the computing device 500 may include a communications component 506 that provides for establishing and maintaining communications with one or more other devices, parties, entities, etc. utilizing hardware, software, and services. The communications component 506 may carry communications between components on the computing device 500, as well as between the computing device 500 and external devices, such as devices located across a communications network and/or devices serially or locally connected to the computing device 500. In an aspect, for example, the communications component 506 may include one or more buses, and may further include transmit chain components and receive chain components associated with a wireless or wired transmitter and receiver, respectively, operable for interfacing with external devices.

Additionally, the computing device 500 may include a data store 508, which can be any suitable combination of hardware and/or software, that provides for mass storage of information, databases, and programs. For example, the data store 508 may be or may include a data repository for applications and/or related parameters not currently being executed by processor 502. In addition, the data store 508 may be a data repository for an operating system, application, display driver, etc., executing on the processor 502, and/or one or more other components of the computing device 500.

The computing device 500 may also include a user interface component 510 operable to receive inputs from a user of the computing device 500 and further operable to generate outputs for presentation to the user (e.g., via a display interface to a display device). The user interface component 510 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 510 may include one or more output devices, including but not limited to a display interface, a speaker, a haptic feedback mechanism, a printer, any other mechanism capable of presenting an output to a user, or any combination thereof.

Further, while the figures illustrate the components and data of the server device 414 and kiosk 434 as being present in a single location, these components and data may alternatively be distributed across different computing devices and different locations in any manner. Consequently, the functions may be implemented by one or more service computing devices, with the various functionality described herein distributed in various ways across the different computing devices 500. Multiple computing devices 500 may be located together or separately, and organized, for example, as virtual servers, server banks and/or server farms. The described functionality may be provided by the servers of a single entity or enterprise, or may be provided by the servers and/or services of multiple different buyers or enterprises.

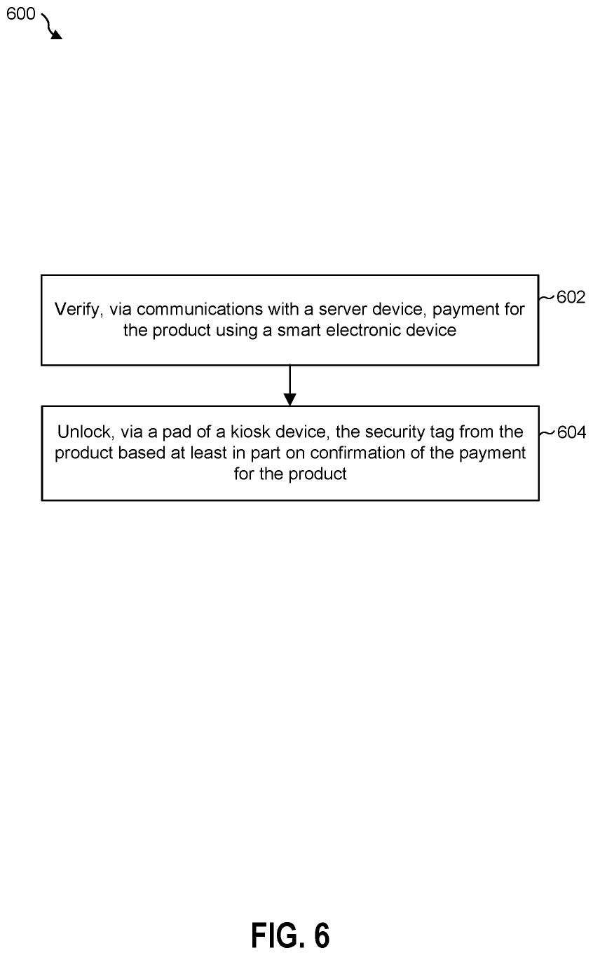

Referring to FIG. 6, in operation, the system may perform an example method 600 for self-checkout for a user within a retail environment. The method 600 may be performed by one or more components of the kiosk or any device/component described herein according to the techniques described with reference to FIGS. 1-5.

At block 602, the method 600 includes verifying, via communications with a server device, payment for the product using an electronic device. For example, the kiosk 434 may determine that a user has employed the electronic device 402 to purchase a four products 412(1)-(4) each having an associated security tag 420 (e.g., the security tags 414(1)-(4)). In some aspects, the first transmitter may detect the security tags 420(1)-(4) attached to the product 412(1)-(4), transmit a verification request 448 including identifiers of the products 412(1)-(4) and/or security tags 420(1)-(4), and receive a response (e.g., the approval information 426) identifying whether the products 412(1)-(4) have been purchased.

Accordingly, the kiosk 434, the computing device 442, and/or the computing device 500 executing the verification module 446 may provide means for verifying, via communications with a server device, payment for the product using an electronic device.

At block 604, the method 600 includes unlocking, via the pad, the security tag from the product based at least in part on confirmation of the payment for the product. For example, upon verifying that the products 412(1)-(4) have been purchased via receipt of the approval information 426 at the verification module 446, the verification module 446 may command the pad 440 to transmit detach commands 430 to the security tags 420(1)-(4) and energize 428 the security tags 420(1)-(4) placed on the pad 440. In some aspects, the detach commands may include an indication of the security tags 420(1)-(4) that are to be unlocked. As described herein, the energization 428 may cause the security tags 420(1)-(4) to automatically detach from the products 412(1)-(4) by unlocking the tacks of the security tags 420(1)-(4). Further, in some aspects, one or more unpurchased products 412(5)-(6) may be placed on the pad 440 with the products 412(1)-(4). However, even if the security tags 414(5)-414(6) tags attached to the unpurchased products receive the energization 428, the security tags 414(5)-414(6) will not unlock because the security tags 414(5)-(6) did not receive detach commands 430 indicating purchase of the products 414(5)-(6).

Accordingly, the kiosk 434, the computing device 442, and/or the computing device 500 executing the verification module 446 may provide means for unlocking, via the pad, the security tag from the product based at least in part on confirmation of the payment for the product.

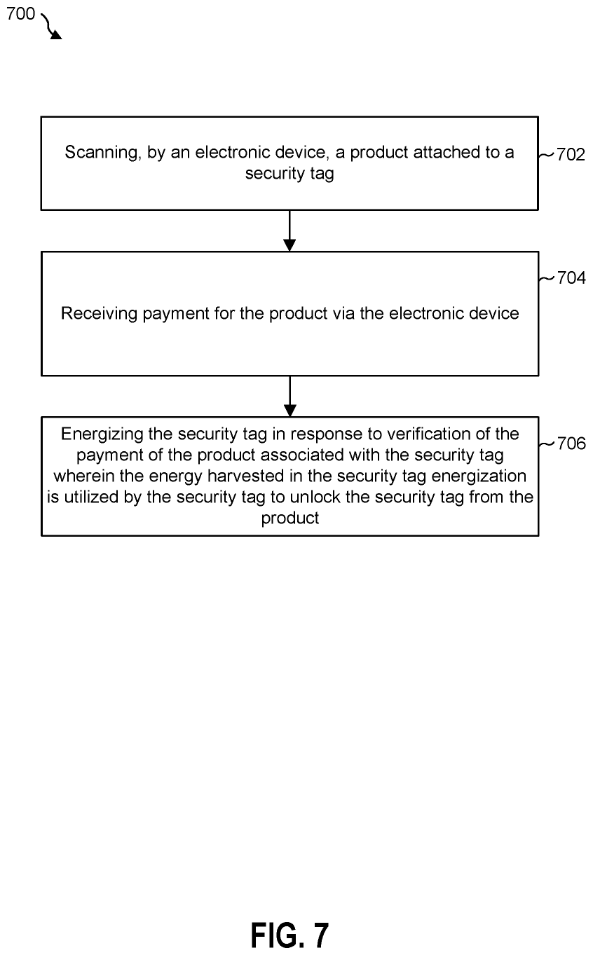

Referring to FIG. 7, in operation, the system may perform an example method 700 for self-checkout for a user within a retail environment. The method 700 may be performed by one or more components of the kiosk or any device/component described herein according to the techniques described with reference to FIGS. 1-5.

At block 702, the method 700 includes scanning, by an electronic device, a product attached to a security tag. For example, a user may select a product 412(1) for purchase within the retail environment 100, and scan an identifier of the product 412(1) via the scanning module 406 of the electronic device 402. In some aspects, the application 404 may determine the details of the product 412(1) based on the scanning.

Accordingly, the electronic device 402 and/or the computing device 500 may provide means for scanning a security tag attached with a product.

At block 704, the method 700 may include receiving payment for the product via the electronic device. For example, the user may pay the price of the product 412(1) via application 404 installed within the electronic device 402. Further, the application 404 may send a payment confirmation 422 to the server device 414 to be stored as payment information 424. In response, the electronic device 402 may receive approval information 426 instructing the application 404 to unlock the tack of the security tag 420(1) of the purchased product 412(1).

Accordingly, the electronic device 402 and/or the computing device 500 executing the application 404 may provide means for receiving payment for the product via the electronic device.

At block 706, the method 700 may include energizing the security tag in response to verification of the payment of the product associated with the security tag wherein the energy harvested in the security tag energization is utilized by the security tag to unlock the security tag from the product. For example, the electronic device 402 may energize 428 the security tag 420(1). Further, in some aspects, the energization results in harvesting energy in the security tag 420(1) which is used for unlocking the tack of the security tag 420(1). As another example, after confirmation of the payment for the product 412(1) associated with the security tag 420(1) by the verification module 446, the pad 440 may energize the security tag 420(1). Further, in some aspects, the energization results in harvesting energy in the security tag 420(1) which is used for unlocking the tack of the security tag 42019).

Accordingly, the electronic device 402 and/or the computing device 500 executing the application 404 may provide means for receiving payment for the product via the electronic device.

### Configuration of Exemplary Aspects

The construction and arrangement of the systems and methods as shown in the various exemplary aspects are illustrative only. Although only a few aspects have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative aspects. Other substitutions, modifications, changes, and omissions can be made in the design, operating conditions and arrangement of the exemplary aspects without departing from the scope of the present disclosure.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While the invention has been described in detail and with reference to specific examples thereof, it will be apparent to one skilled in the art that various changes and modifications can be made therein without departing from the spirit and scope thereof.

What is claimed is:

1. A self-checkout system in a retail environment, the self-checkout system comprising:
a security tag attached to a product; and
a kiosk comprising:
a pad for placement of security tags and products; and
a memory storing computer-executable instructions and at least one processor coupled with the memory and configured to:
verify, via communications with a server device, payment for the product using an electronic device; and
unlock, via the pad, the security tag from the product based at least in part on confirmation of the payment for the product.

2. The self-checkout system of claim 1, wherein the pad is configured to energize the security tag to cause the security tag to harvest energy and unlock from the product.

3. The self-checkout system of claim 2, wherein to unlock the security tag from the product, the at least one processor is further configured to:
transmit, to the security tag, a command including an identifier of the security tag and/or the product, the command causing the security tag to unlock when energized by the pad.

4. The self-checkout system of claim 1, wherein the kiosk further comprises:
a first transmitter configured to detect the security tag placed on the pad; and
a second transmitter configured to transmit and receive the communications verifying the payment for the product in response to the first transmitter detecting the security tag.

5. The self-checkout system of claim 4, wherein the first transmitter is further configured to transmit a command to the pad to unlock the security tag in response to receipt of the communications verifying the payment for the product.

6. The self-checkout system of claim 1, further comprising the electronic device configured to:
scan the security tag attached to the product;
receive payment for the product; and
indicate receipt of payment for the product to the server device.

7. The self-checkout system of claim 1, wherein the at least one processor is further configured to:
receive payment for the product via an electronic device.

8. The self-checkout system of claim 1, further comprising a catch bin for receiving the security tag after the security tag has been unlocked from the product.

9. The self-checkout system of claim 1, wherein the security tag is a first security tag, the product is a first product, the communications are first communications, and the at least one processor is further configured to:
determine that a second security tag attached to a second product and a third security tag attached a third product have been placed on the pad;
verify, via second communications with the server device, payment for the second product and non-payment for the third product;
transmit, to a second security tag attached to the second product in response to the second communications, a command including an identifier of the second security tag and/or the second product; and
energize the second security tag and the third security tag, the energizing causing the second security tag to harvest energy and unlock from the second product and causing the third security tag to harvest energy and remain locked to the third product.

10. A non-transitory computer-readable medium for managing access to a secured area, the non-transitory computer-readable medium having instructions thereon that, when executed by at least one computing device, causes the at least one computing device to perform operations comprising:
verifying, by a kiosk, via communications with a server device, payment for a product scanned by an electronic device;
transmitting, by the kiosk, to a security tag attached to the product based at least in part on the verifying, a command including an identifier of the security tag and/or the product, the command approving unlocking of the security tag; and
unlocking, by the kiosk, the security tag from the product based at least in part on confirmation of the payment for the product.

11. The non-transitory computer-readable medium of claim 10, wherein unlocking the security tag comprises:
energizing the security tag in response to the verifying, wherein energy harvested during energization of the security tag is utilized by the security tag to unlock the security tag from the product based at least in part on the command.

12. The non-transitory computer-readable medium of claim 10, wherein the operations further comprise:
detecting, via a first transmitter of the kiosk, that the security tag has been placed on a pad of the kiosk; and
transmitting and receiving, via a second transmitter of the kiosk, the communications verifying the payment for the product in response to first transmitter detecting the security tag.

13. The non-transitory computer-readable medium of claim 10, wherein the security tag is a first security tag, the product is a first product, the communications are first communications, and the operations further comprise:
determining that a second security tag attached to a second product and a third security tag attached a third product have been placed on a pad;
verifying, via second communications with the server device, payment for the second product and non-payment for the third product;
transmitting, to a second security tag attached to the second product in response to the second communications, a command including an identifier of the second security tag and/or the second product; and
energizing the second security tag and the third security tag, the energizing causing the second security tag to harvest energy and unlock from the second product and causing the third security tag to harvest energy and remain locked to the third product.

14. A method for self-checkout for a user within a retail environment, the method comprising:
scanning, by an electronic device, a product attached to a security tag;
receiving payment for the product via the electronic device; and
energizing the security tag in response to verification of the payment of the product associated with the security tag wherein energy harvested during energization is utilized by the security tag to unlock the security tag from the product.

15. The method of claim 14, further comprising:
sending, to a server device, identification information identifying the product; and
receiving, from the server device, the verification of the payment of the product.

16. The method of claim 14, further comprising:
transmitting a command including an identifier of the security tag and/or the product, the command causing the security tag to unlock in response to being energized.

17. The method of claim 14, wherein the security tag is a first security tag, the product is a first product, and further comprising:
determining that a second security tag attached to a second product and a third security tag attached a third product have been placed on a pad;
verifying, via communications with the server device, payment for a second product attached to a second security tag and non-payment for the third product attached to a third security tag;
transmitting, to a second security tag attached to the second product in response to the second communications, a command including an identifier of the second security tag and/or the second product; and
energizing the second security tag and the third security tag, the energizing causing the second security tag to harvest energy and unlock from the second product and causing the third security tag to harvest energy and remain locked to the third product.

18. The method of claim 14, wherein energizing the security tag in response to verification of the payment for the product associated with the security tag comprises energizing the security tag via the electronic device.

19. The method of claim 14, wherein energizing the security tag in response to verification of the payment for the product associated with the security tag comprises energizing the security tag via a kiosk device.

20. The method of claim 19, further comprising:
detecting, via a first transmitter of the kiosk, the security tag being placed on a pad of the kiosk; and
transmitting and receiving, via a second transmitter, communications verifying the payment for the product in response to the first transmitter detecting the security tag.
